(19) United States
(12) Patent Application Publication
(10) Pub. No.: US 2015/0226460 A1
(43) Pub. Date: Aug. 13, 2015

(54) REAL-TIME BOILER FORECAST SYSTEM AND METHOD

(71) Applicant: Shai ZEMACH, Kfar Yona (IL)

(72) Inventor: Shai ZEMACH, Kfar Yona (IL)

(21) Appl. No.: 14/178,344

(22) Filed: Feb. 12, 2014

(51) Int. Cl. F24J 2/34; G05B 15/02

(52) U.S. Cl. CPC F24J 2/345; G05B 15/02

(57) ABSTRACT

A retrofit water boiler monitoring and forecast system, method and computer program product, for a water boiler system which includes a water boiler, a cold-water pipe, a hot-water pipe, including: an intake temperature sensor, configured to measure a water temperature in the cold-water intake pipe; a flow meter, configured to measure a flow rate of water running through the water boiler system; an outlet temperature sensor, configured to measure a water temperature in the hot-water outlet pipe; a processing unit, adapted to receive sensor data from the intake temperature sensor, flow meter, and outlet temperature sensor, and configured to calculate an amount of available hot water in the water boiler based on the sensor data; and a display panel coupled to the processing unit configured to display at least one estimated Real-Time Usage Value, calculated by the processing unit based on the amount of available hot water.

### FIELD AND BACKGROUND OF THE INVENTION

The present invention relates to a system for improving energy efficiency related to household water boilers and, more particularly, to a system for monitoring heated water in a boiler and forecasting usage needs.

It is the purpose of most ‘Green Tech’ devices and systems to conserve energy resources by improving energy consumption methods or offering alternative resources. To date heating household water is by and large an unchecked source of energy consumption in developed countries, where the household water is constantly heated all day long throughout the year. Some countries make use of solar heating mechanisms to supplement electrical heating of the household water heater (boiler), particularly in the summer months. Due to conservation concerns, the rise in fuel product prices causing a rise in the prices of electricity and the concern over pollution caused by power stations, there is a need for a system to help regulate electrical consumption, and specifically for monitoring energy consumption in the process of heating household water.

It would therefore be highly advantageous to have a real-time indication of the amount of available hot water for use in a household with multiple hot water users. To that end it would be advantageous to have a real-time indication of how water usage (flow rate and water temperature) effects energy consumption and boiler status.

### SUMMARY OF THE INVENTION

According to the present invention there is provided a retrofit water boiler monitoring and forecast system, for a water boiler system which includes a water boiler, a cold-water intake pipe, a hot-water outlet pipe, the retrofit system including: (a) an intake temperature sensor, configured to measure a water temperature in the cold-water intake pipe; (b) a flow meter, configured to measure a flow rate of water running through the water boiler system; (c) an outlet temperature sensor, configured to measure a water temperature in the hot-water outlet pipe; (d) a processing unit, adapted to receive sensor data from the intake temperature sensor, the flow meter, and the outlet temperature sensor, and configured to calculate an amount of available hot water in the water boiler, based on the sensor data; and (e) a display panel operationally coupled to the processing unit, the display panel configured to display at least one estimated Real-Time Usage Value (RTUV), calculated by the processing unit based on the amount of available hot water.

According to further features in preferred embodiments of the invention described below the system further includes: (f) a control panel operationally coupled to the processing unit, including a user interface adapted to receive instructions for programming and controlling the processing unit.

According to still further features in the described preferred embodiments the control panel is operationally coupled to an activation switch of the water boiler.

According to still further features the processing unit includes: a non-transient memory adapted to retrievably store usage data, the usage data including the sensor data recorded over time.

According to still further features the display panel is adapted to be mounted in a bathing area.

According to still further features the at least one estimated RTUV is an estimated amount of time remaining during which the hot water will be available, based on the flow rate.

According to still further features the at least one estimated RTUV includes a number of distinct hot-water activities that can be completed with the amount of available hot water.

According to still further features another estimated RTUV displayed on the display panel includes a measure of time remaining for completing one of the distinct hot water activities, based on the flow rate.

According to still further features the another estimated RTUV displayed on the display panel includes a measure of time remaining for completing one of the distinct hot water activities, based on the flow rate.

According to still further features the at least one Real-Time Usage Value includes an indication of a working condition of a heating element of the water boiler system.

According to still further features the working condition of the heating element is calculated based on the sensor data compared to the usage data.

According to still further features the processing unit includes logic for calculating the amount of available hot water, the logic including an adaptive learning algorithm configured to learn characteristics of the water boiler system based on the usage data stored in the non-transient memory.

According to still further features the amount of available hot water is calculated based on the learned characteristics of the water boiler system.

According to still further features the amount of available hot water is further calculated based on learned usage characteristics of the water boiler.

According to still further features the processor calculates a relative level of efficiency of a heating element of the water boiler system, based on the learned characteristics of the water boiler system.

According to still further features the processing unit includes logic for calculating the amount of available hot water, the logic including an adaptive learning algorithm configured to learn usage characteristics of the water boiler based on the usage data.

According to still further features the amount of available hot water is further calculated based on learned characteristics of the water boiler.

According to still further features the processing unit includes logic configured to detect a leak in the water boiler system, based on the sensor data.

According to still further features the processing unit is configured to distinguish between sources of hot-water usage.

According to still further features the system is further adapted for use with a water boiler system including a solar collector, the retrofit system further comprising at least one of: (i) a second flow meter adapted to measure water flow through the solar collector operationally coupled to the water boiler; (ii) a solar collector outlet sensor adapted to measure temperature of water flowing from the solar collector to the water boiler; and (iii) a solar collector intake sensor adapted to measure temperature of water flowing from the water boiler to the solar collector.

According to still further features the system further includes a photo voltaic (PV) cell, the PV cell being adapted to provide solar-related data.

According to still further features the PV cell further produces usable energy.

According to still further features the usable energy is adapted to power at least the retrofit system.

According to another embodiment there is provided a method for providing a real-time estimate of available hot water in a hot water boiler, the method including the steps of: (a) receiving flow data; (b) receiving an outlet temperature measurement of water in a boiler outlet pipe; and (c) receiving an intake temperature measurement of water in a boiler intake pipe; (d) calculating an estimated amount of hot water in the boiler based on the flow data, outlet temperature measurement and intake temperature measurement.

According to still further features the system further includes the step of: (e) receiving a thermostat value, prior to step (d).

According to still further features the flow data includes at least one of: a flow rate value and a flow duration value.

According to another embodiment there is provided a method and a computer program product embodied on a non-transitory storage medium and executed via a processor for calculating an estimated amount of hot water in a water boiler, including the steps of: (a) receiving sensor data over a predetermined time interval, the sensor data including at least: flow data, an outlet temperature measurement of water in a boiler outlet pipe and an intake temperature measurement of water in a boiler intake pipe; (b) comparing the received sensor data with stored sensor data; and (c) calculating, based on the comparison, an approximate amount of available hot water in the water boiler.

According to still further features the method further includes the step of: (d) storing the received sensor data on a non-transient storage medium.

According to still further features the stored sensor data includes aggregated sensor data.

According to still further features the method further includes the step of: (d) analyzing the flow sensor data so as to extrapolate usage data.

According to still further features the usage data includes: (i) distinct usage activities, (ii) usage patterns for the distinct usage activities.

According to still further features the method further includes the steps of: (e) calculating, based on the estimated amount of available hot water and the usage patterns, an amount of the distinct usage activities that can be effected; and (f) displaying the amount of distinct usage activities that can be effected.

According to still further features the method further includes the steps of: (e) forecasting, based on the estimated amount of available hot water and the flow sensor data, an amount of time delta for which hot water will be available from the water boiler; and (f) displaying the time delta.

According to still further features the method further includes the step of: (d) analyzing the sensor data to extrapolate water boiler characteristics.

According to still further features the water boiler characteristics include at least one of: (i) boiler efficiency, (ii) heating time, (iii) water leakage, and (iv) environmental affect on the heating time.

### BRIEF DESCRIPTION OF THE DRAWINGS

Various embodiments are herein described, by way of example only, with reference to the accompanying drawings, wherein:

FIG. 1 is a block diagram of a basic system of the immediate innovation;

FIG. 2 is a pictorial depiction of a boiler system augmented with an exemplary configuration of the system of FIG. 1;

FIG. 3 is a pictorial depiction of a boiler system with solar panel, augmented with an exemplary configuration of the system of FIG. 1;

FIG. 4 is a pictorial depiction of a boiler system with solar panel, augmented with another exemplary configuration of the system of FIG. 1;

FIG. 5 is a pictorial depiction of a boiler system with solar panel, augmented with yet another exemplary configuration of the system of FIG. 1;

FIG. 6 is a main flow diagram of the innovative method of the immediate invention;

FIG. 7 is a flow diagram of data sub routine;

FIG. 8 is a flow diagram of a data processing subroutine;

FIG. 9 is a flow diagram of a display routine.

### DESCRIPTION OF THE PREFERRED EMBODIMENTS

The principles and operation of a retrofit or integrated monitoring and forecast system for a household water heater according to the present invention may be better understood with reference to the drawings and the accompanying description.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Various embodiments of the invention include the same basic components. Similar components are indicated with a reference number with the same last two-digits but with a first digit which signifies the Figure number.

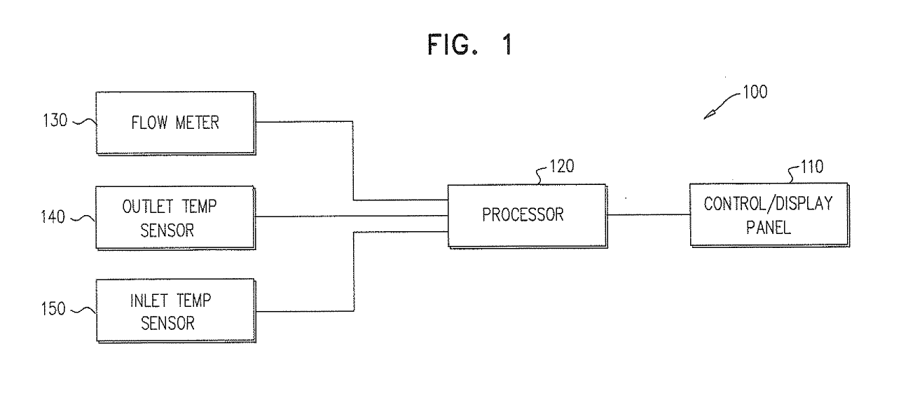

Referring now to the drawings, FIG. 1 illustrates a block diagram of a basic system 100 of the immediate innovation. The immediate system is a retrofit monitoring system in which a processing unit/processor 120 receives measurement values in the form of sensor data from sensors adapted to be attached to a water heater system. Processor 120 is a general purpose microprocessor, a processor implemented using digital signal processing (DSP) or an application specific integrated circuit (ASIC) or a combination of the different technologies and/or other similar technologies. Processing unit 120 may include a plurality of microprocessors and/or additional components known in the art. Preferably, the processing unit further includes a memory for storing usage data. The memory may be a transient memory storage unit, a non-transient memory storage unit or a combination of both. In some embodiments, the processing unit stores and retrieves usage data to and from the memory in or to improve the accuracy of the various calculations of available hot-water, amount of hot-water needed for predefined or requested tasks etc. Usage data includes sensor data recorded over time as well as any other relevant pieces of data.

The sensors include a flow meter 130, an outlet temperature sensor (TS) 140 and an intake temperature sensor 150. The flow meter and inlet TS are adapted to be attached to the inlet/intake pipe which runs from the house water mains to the water heater, bringing cold water in to be warmed in the heater/boiler. The outlet TS is adapted to be attached to the hot outlet pipe running from the boiler to the hot water distribution system in the house. The sensors relay the flow rate of water entering/leaving the boiler and the temperatures of the incoming cold water and outgoing hot water to the processing unit via wired or wireless means.

Processor 120 receives at least the aforementioned information/values from the sensors (the flow meter is considered a sensor as it senses the rate of water flow even though technically it is a meter, which counts the amount of water passing through the apparatus, both terms are considered synonymous herein) and calculates the approximate amount of hot water available in the water boiler, based on the received sensor data. The processing unit uses flow rate algorithms, and in some embodiments, additional temperature and usage information (e.g. the volume of the boiler tank, thermostat activity, historical usage and the like), to deduce the approximate amount of hot water remaining in the boiler.

The processing unit uses the calculated amount of hot water, which is constantly updated in real-time (based on sensor data which is produced and transmitted to the processor on an ongoing basis), to estimate various Real-Time Usage Values (RTUV). Usage values can be, for example, the amount of hot water available in the water boiler, the amount of time remaining during which hot water will be available, the number of hot-water activities that can be accomplished before the hot water runs out, the amount of time remaining before the requisite amount of hot water is available, the status of the heating element and more. The derived usage values (time remaining, number of hot water activities available, working condition of the heating element, etc.) are appropriately displayed on a control/display panel 110.

In some embodiments, the control panel is separate from the display panel. The control panel includes a user interface (touch screen, buttons, other types of actuators, etc.) for directly controlling the water boiler functions (via the processing unit) and/or for programming the processing unit to perform desired tasks at desired times. In both embodiments, the control panel is connected, at least, to the activation switch of the water boiler. In some embodiments, the control panel can be programmed to provide a predefined (approximate) amount of hot water, or a sufficient hot water for a required/requested number of hot-water activities. In all cases, the control panel can be used to set predefined parameters for heating certain amounts of water at certain times, or ensuring that a required amount of hot water is available at requested times. In some embodiments, the display panel can display an approximate amount of time needing to elapse before the requested amount of hot water is ready. The displayed information reflects calculations made by processing unit 120 based on substantially real-time sensor information.

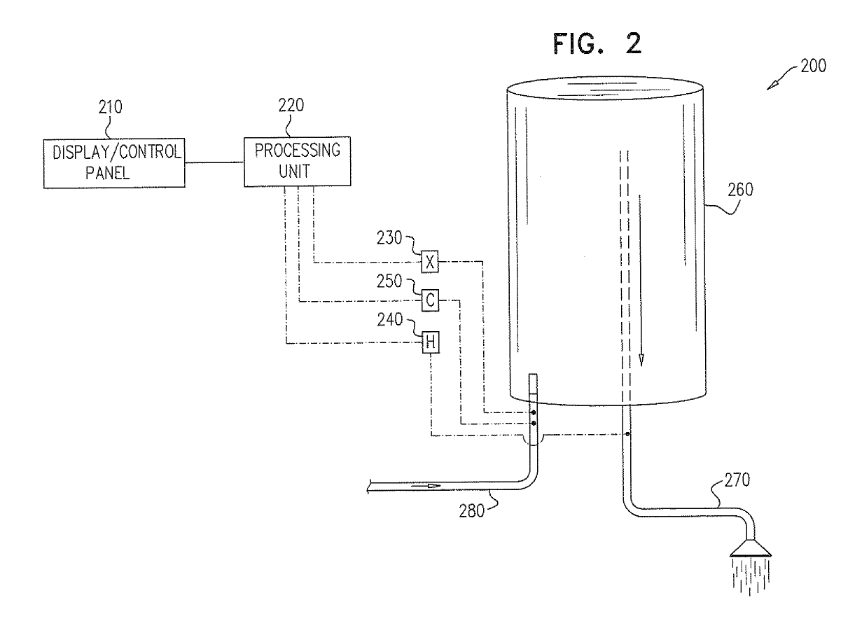

FIG. 2 depicts an embodiment of the system of FIG. 1, wherein a water heater (boiler) system 200 is augmented with the exemplary configuration of the immediate monitoring and forecast system. A typical water boiler system includes a water boiler 260, a cold-water intake pipe 280 which brings in cold water from an external source, and a hot water outlet pipe 270 from the boiler (usually located near the top of the boiler where the hottest water is found) to the household system of pipes for dispersion throughout the house (e.g. to the bathroom, kitchen, laundry room etc.).

In the depicted, exemplary configuration, the system collects data from three sensors assembled on the boiler: a first temperature sensor (C) 250 measures the temperature of the water in the intake line 280; a second temperature sensor (H) 240 measures the temperature of the water in hot-water outlet pipe leading out of the boiler; and a flow meter (X) 230 which measures the flow rate of water moving through the cold-water intake line, into the boiler. The flow rate sensor can be placed on either the intake or outlet lines as the boiler system is a closed system (however much water leaves the water heater must come into the water heater from the intake pipe), although the flow meter of the immediate embodiment of the invention measures flow rate on the intake line (providing a further feature of sensing a leak in the boiler, see below). The sensors (the flow meter is considered a sensor for all intents and purposed) record and/or transmit the sensed data to a processing unit 220 for processing.

The system analyzes input from the sensors, calculates the amount of available hot water and displays a real-time estimation of water availability on a display unit 210 (preferably located in the bathing area such as a shower or bathroom). In a basic embodiment, the estimation of available hot water is based on the sensed values of water temperature (intake and outlet values as well as heating duration, and in some embodiments—thermostat values) and flow rate of hot water in use. The system is capable of learning the heating properties of the boiler, as well as user habits, in order to create a more efficient and economical heating plan.

In some embodiments, the processing unit includes logic for an adaptive learning algorithm configured to learn the characteristics of the water boiler system. For example, the processing unit records heating history of the water boiler, such as: duration of active heating element, intake temperatures, thermostat readings etc. Exemplarily, the processing logic estimates the relative heating efficiency of the heating element of the boiler, based on a comparative study of heating times.

‘Logic’ is defined, within the meaning of this document, as a set of instructions or programming embodied in software, firmware and/or hardware for effecting various actions and/or processes. The logic may be in the form of a computer program product or programming embodied on a computer readable medium such as transient or non-transient memory and executed via a processor. Alternatively stated, the logic or programming may be embodied on a transitory or non-transitory storage medium and executed via a processor.

In some embodiments, the processing unit includes logic for an adaptive learning algorithm configured to learn usage characteristics of the water boiler. Generally, the processing component includes predefined usage values for bathing and other water use activities. For example, an average bath uses 13-15 gallons of hot water whereas an average shower uses about 6-8 gallons of hot water. Of course, individual usage will vary. For example, children generally shower for longer than adults. On the other hand, a bath for a child generally uses less water than a bath for an adult. Therefore, the learning algorithm identifies distinct bathing activities (e.g. adult shower, adult bath, child shower, child bath) as well as other hot water usage activities such as: washing machine, dishwasher, sink use, incidental use (hot water drawn from the boiler but not reaching the faucet outlet, a common cause is a single faucet for cold and hot water that is accidentally opened to draw hot water during short usage such as washing hands or food).

In some embodiments the processor learns the particular behaviors of the household system, including the number of hot water usage activities and when the activities generally take place. For example, the system can determine that each evening between 6 pm and 8 pm two long showers take place (child showers) while between the hours of 9 pm to 11 pm, two short showers take place (adult showers).

In some embodiments the processor includes logic for determining if there is a leak in the boiler system. In a simple configuration, the system determines whether there is a leak in the hot water system by detecting a constant flow of water through the system, sensed by the flow meter. In other configurations, the system may alternatively or additionally determine a leak or likelihood of a leak based on unexpected results such as higher the usual water usage over a given amount of time; and/or cooler water than predicted (possibly due to the constant introduction of cold water into the hot water boiler); and/or higher electricity/power usage than expected.

Real-Time Calculation and Display

Whenever the processor receives new sensor data from the sensors or thermostat, the processor calculates a new or updated estimate of available hot water and, if applicable, immediately displays the new calculation data on the display panel. In this manner, the system provides a real-time estimate of available bathing water. For example, at a given time in the evening, the display shows that there is sufficient hot water for four showers (two short and two long); a member of the house has a shower for an average amount of time; after the shower, the display shows that there is now only enough hot water for three showers. When the hot water system is not in active use (i.e. the heating element is not activated or no hot water is being used), the calculated data may only be updated and/or displayed periodically. Exemplarily, the calculation is made based on some or all of: the thermostat reading of the boiler (whether an actual temperature or simply an indication of ‘active’ or ‘inactive’), the volume of the boiler tank, the heat of the water leaving the tank, the temperature of the cold water entering the tank, and the flow rate.

Continuing the previous example, the display can be positioned in the shower (waterproof and with shielded wires or wireless communication etc.), and show, as a function of time (rather than units of bathing activities) how much hot water remains in the tank, at the present output rate. The user can then adjust the hot-to-cold water ratio or the overall output rate. Either activity would be reflected in a real-time change in the estimate of available hot water (displayed as a function of time).

In one embodiment, the display can show an amount of water available for a particular shower (e.g. each family member is apportioned X amount of hot water for a shower). The family member can adjust the flow rate and/or hot-to-cold ratio in order to increase the amount of time in the shower. The experience can be very educational, teaching the user how to optimize water use in general and hot water user in particular. The display also heightens user-awareness regarding the amount of water being used. Conservation increases with awareness and education. A real-time display of water usage over time is a very good educational and awareness tool.

For example, 6.5 gallons (average amount of hot water used in a shower) is approximately 25 liters; if 25 liters of water are available in the hot water tank and the hot water flow rate is 5 liters per minute, then (discounting additional factors for the sake of simplifying the example) the hot water will run out after 5 minutes. The display on the shower wall shows a counter counting down from 5 minutes to zero. The user understands that at that rate the shower will be very short. The user then adjust the flow rate either by reducing the velocity of the water in the shower or lowering the ratio of hot water to cold water or both. The new flow rate (received from the flow meter) shows that the hot water is now coming out at a rate of 2.5 liters per minute, changing the counter to display 10 minutes. If the amount of water available is X and the flow rate is F then the time T left for using the available hot water can be calculated as: T=X/F.

Of course, this is an oversimplification as the amount of hot water varies as a result of usage. In fact available ‘hot’ water is not a constant but rather a range of temperatures. For example, available hot water can be defined as the amount of water that is heated to a temperature between 30° C. and 70° C. More preferably the range is between 40° C. and 60° C. Most preferably, the range is between 45° C. and 55° C.

In one embodiment, an additional flow-meter (not shown) is attached to the household intake pipe. Data from the flow meter provides overall water-usage data, besides for the hot water usage data. Displaying the overall water usage improves the educational and awareness aspects of the system.

In some embodiments, the display panel can provide different display modes. For example, one mode can display the number of showers available (as above), another mode can show the number of baths available, a third mode can show the amount of time available (as discussed above) before the hot water runs out. Other display modes can include dishwasher usage, washing machine usage and sink usage. A discerning user will then be able to plan when and for how long to activate the heating element of the boiler system (if practical/available) and/or plan various activities so that there will be hot water available for each activity (e.g. only run the dishwasher after the children have showered, but not too late so that the water heater will have time to heat the tank enough for later showers). The system can be programmable and automated. The user can program a daily shower regimen (e.g. two early showers and two late showers as exemplarily discussed above) and the system will ensure available hot water for each of the desired activities. Therefore, if the dishwasher, for example, is run unexpectedly (i.e. not scheduled or programmed into the system), the microprocessor will activate the boiler system to ensure that there is sufficient hot water for the scheduled events (e.g. bath, shower, washing machine etc.).

In some embodiments of the invention, the processing unit is capable of discerning different sources of water-usage. For example, a slow flow rate over a relatively short duration of time indicates sink use, while a higher rate over the same time or less can be attributed to a shower activity. Various studies have shown average flow rates of distinct activities, such as the NREL¹ study titled Performance Comparison of Residential Hot Water Systems², published March 2003. Figure X shows Table 3 of the study, including the estimated Gallon Per Minute (GPM) usage of various faucets in a house, corresponding to various activities (e.g. kitchen faucet includes dishwasher use and sink use; laundry faucet includes the washing machine etc.). ¹ National Renewable Energy Laboratory, NREL is a U.S. Department of Energy Laboratory Operated by Midwest Research Institute • Battelle • Bechtel² Available for sale to the public, in paper, from: U.S. Department of Commerce National Technical Information Service, 5285 Port Royal Road, Springfield, Va. 22161

In some embodiments, the processing logic combines known and/or learned values together with learned usage behaviors and/or characteristics of the boiler system to estimate availability.

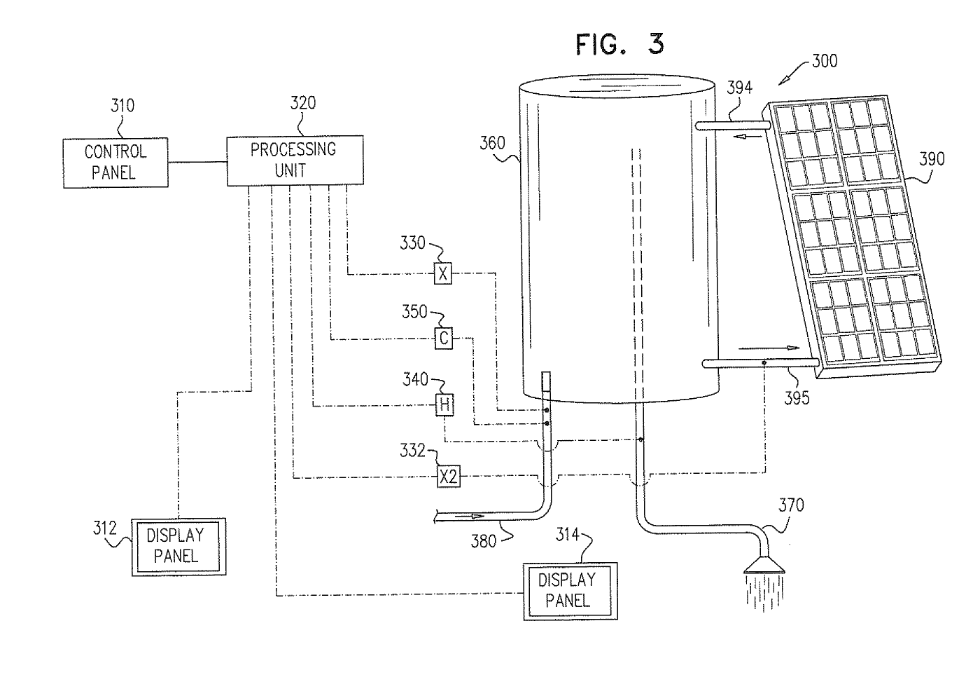

Another possible configuration is shown in FIG. 3. FIG. 3 depicts a hot water system with a solar water heating panel, augmented with an embodiment of the immediate system. Solar water heating (SWH) or solar hot water (SHW) systems comprise several innovations and many mature renewable energy technologies that have been well established for many years. SWH has been widely used in Australia, Austria, China, Cyprus, Greece, India, Israel, Japan and Turkey.

Passive systems rely on heat-driven convection or heat pipes to circulate water or heating fluid in the system. Passive solar water heating systems cost less and have extremely low or no maintenance, but the efficiency of a passive system is significantly lower than that of an active system. Overheating and freezing are major concerns. In some embodiments of the invention, sensors can indicate freezing and/or overheating. The processor can sound an alarm or issue an alert regarding the freezing or overheating. Automatic systems can prevent overheating by cutting power to the heating element of the boiler system, for example.

Active systems use one or more pumps to circulate water and/or heating fluid in the system. In some situations, water drawn from the boiler can be pumped into the solar panel, ostensibly to be heated, but where in fact the water is being cooled by the process. Based on sensor information, the system can instruct the pump to stop pumping water to the panels if the water exiting the solar panel is cooler than the water entering the panel. Likewise, other similar situations of energy wastage can similarly be prevented based on the sensor data and corresponding logic in the processor.

An exemplary hot water system 300 includes a boiler 360 coupled to a solar heating panel/collector 390 of a passive system. Solar panel 390 receives cool water from the lower regions of the boiler 360 which runs through the collectors of the solar panel and outputs the heated water back into an upper region of boiler 360. Here too, the system collects data from three sensors assembled on the boiler: a first temperature sensor (C) 350 measures the temperature of the water in the intake line 380; a second temperature sensor (H) 340 measures the temperature of the water in hot-water outlet pipe leading out of the boiler; and a flow meter (X) 330 which measures the flow rate of water moving through the cold-water intake line, into the boiler. In addition, a second flow meter (2X) 332 measures the flow rate of water running from the water boiler/boiler tank 60 to the collector 390 via a connecting pipe 395 which carries cooler water to the collector. A collector outlet pipe 395 carries (heated) water from the collector back to the boiler tank. Of course the second flow meter could be positioned in other places on the solar collector or connecting pipes, such as on the solar collector outlet pipe 394. In any of the aforementioned configurations the second flow meter (2X) 332 measures the flow of water passing through the solar collector.

In the immediate exemplary embodiment, a control panel 320 is operationally coupled to a processing unit 320. Exemplarily the control panel can be conveniently located in a house, possibly outside a family bathroom. The control panel allows users to program heating times, duration of a heating period and so forth. Further in the exemplary embodiment, a first display panel 312 is separate from the control panel. Exemplarily, first display panel 312 can be located in a family shower/bath area. Preferably, the panel is waterproof and otherwise protected from steam, humidity and other elements commonly found in a bathing area. The display can be designed and programmed to display current water and/or hot water usage as well as an approximation of remaining available hot water displayed as any appropriate value. For example, the remaining hot water can be displayed in liquid measurements, or, more preferably amount of remaining time left before all the hot water is used up, possibly an estimated number of bathing activities that can be accomplished with the remaining hot water. The display is configured to provide real-time estimates directly related to the usage at the time. Therefore, manipulation of the flow and/or hot to cold water mix ratio, will be reflected on the display. Exemplarily, lowering the flow of hot water will increase the displayed amount of available hot water.

A second, exemplary display panel 314 is also depicted. Potentially the second display can be located in the master bathroom or kitchen. Either way, users of hot water will similarly be able to gage how much hot water is available and plan or use the hot water accordingly.

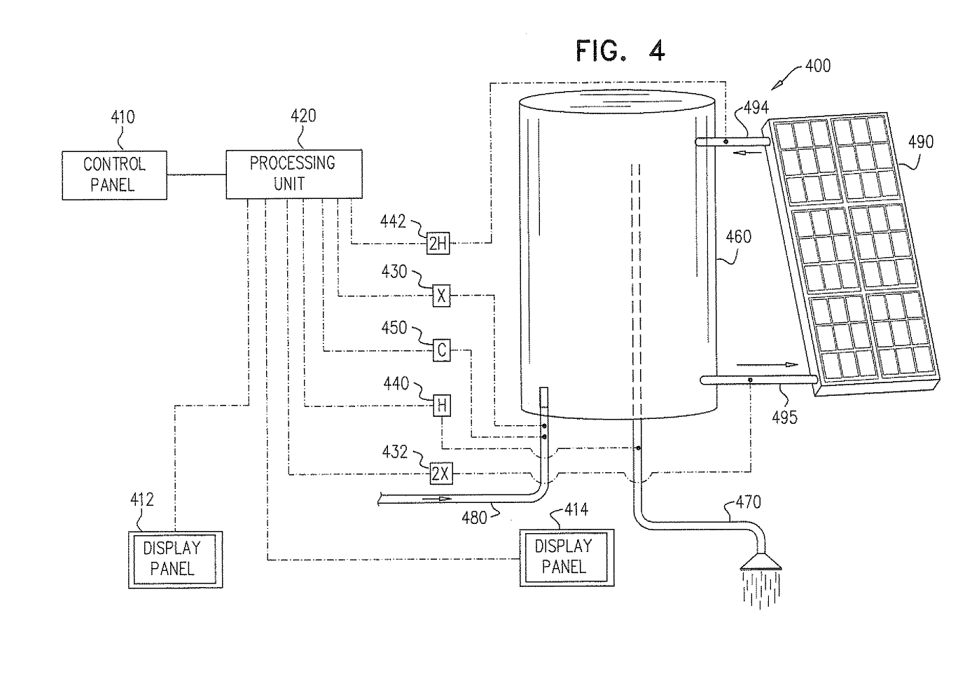

Yet another configuration is shown in FIG. 4 which depicts a system 400 similar to that of FIG. 3 with the single difference of an additional hot water/solar collector outlet TS (2H) 442. The solar collector outlet sensor (2H) 442 is adapted to measure the temperature of water flowing from the solar collector to the water boiler/boiler tank 60. The flow rate value received from flow meter 2X 332/432 indicates how efficiently the collector is heating the water. The speed at which water enters the collector is indicative of the relative heat the collector is collecting above the heat of the water entering the collector; the faster the flow of water into the collector, the hotter the collector (at least from a monitoring point of view). By adding an additional sensor, a more exact estimation can be made of the available hot water. Knowing how much hot water is entering the tank 460, and how hot the water actually is, improves the accuracy of the estimation algorithm. Furthermore, the additional sensor can also give a better indication of the efficiency of the heating element, and whether the element needs to be repaired or replaced.

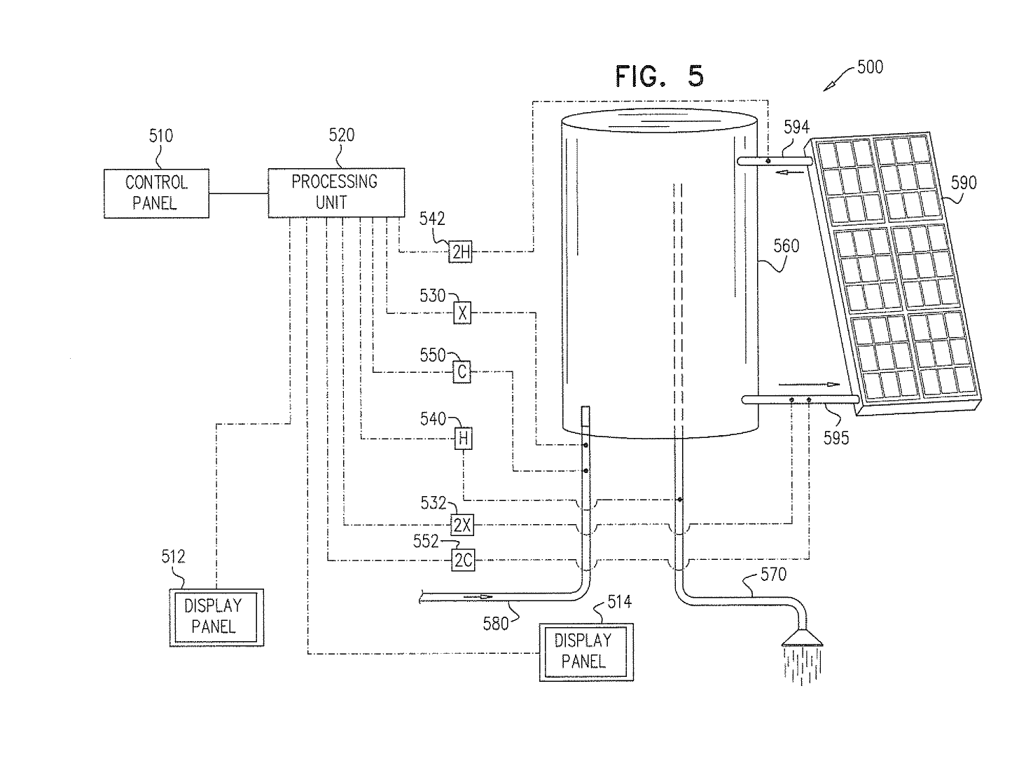

Yet another configuration is shown in FIG. 5 which depicts a system 500 similar to that of FIG. 4 with the single difference of an addition solar collector intake/inlet TS (2C) 552. The solar collector intake sensor is adapted to measure the temperature of water flowing from the water boiler/boiler tank 60 to the solar collector 390. The retrofit system of the immediate invention is non-invasive with regards to the existing hardware. No sensors are inserted into the boiler tank or collector. As a result, the exact temperature of the water in the boiler is largely unknown and merely estimated. Of course, the water temperature in the boiler tank itself differs from place to place. The hottest water is in contact with the boiler element, and is funneled up the boiler cone to the top of the tank. Cooler water descends to the bottom of the tank. By attaching TS 552 to the collector inlet pipe 595 the processor can more accurately determine the amount of hot water in the tank based on the additional information regarding the temperature of the cooler water in the tank. As above, the additional sensor can also give a better indication of the efficiency of the heating element, and whether the element needs to be repaired or replaced.

Of course, the configurations shown in FIGS. 3-5 are merely exemplary and other combinations or configurations can equally be applied. For example, a configuration with only a solar collector outlet sensor is envisioned, without the second flow meter. In another example, a solar collector outlet sensor and a solar collector intake sensor are included in the system configuration but not an additional flow meter. Numerous variations are possible.

Additional sources of temperature data can be attained from the boiler thermostat. Generally, a thermostat is set at a predefined temperature. When the water reaches the desired temperature (e.g. 65 degrees Celsius) the boiler element switches off. When the water cools to a temperature below a predefined differential (e.g. 5 degrees Celsius), the boiler element switches back on. The thermostat information provides the processor 120/220/320/420/520 with an indication of a temperature range sensed by the thermostat. For example, if a thermostat is set to heat the water to 65° C. with a differential of 10° C., then if the thermostat is active the processor knows that the temperature inside the boiler tank (at least where the thermostat sensor is situated) is below 65° C.; if the thermostat subsequently deactivates then the temperature is between 65° C. and 55° C.; when the thermostat subsequently re-activates then the processor knows that the temperature is rising between 55° C. and 65° C.

In an additional exemplary embodiment, a photovoltaic cell (not shown) can be part of the retrofit system, attached to or near the solar collectors. The photovoltaic cell or solar cell can provide data regarding efficiency of the solar collectors (e.g. the amount of energy produced by the PV is an indication of how the solar collectors should be heating the water). Furthermore, the solar cell can provide additional ‘clean’ energy for powering the forecasting system of the immediate invention. In this manner, the system draws very little, if any, additional power from the power grid. As such, the system can work independently of a power grid, such as in a remote location or in a caravan/RV/trailer, on a boat or ship. The water is heated by a solar panel and the retrofit system is powered by the PV cell.

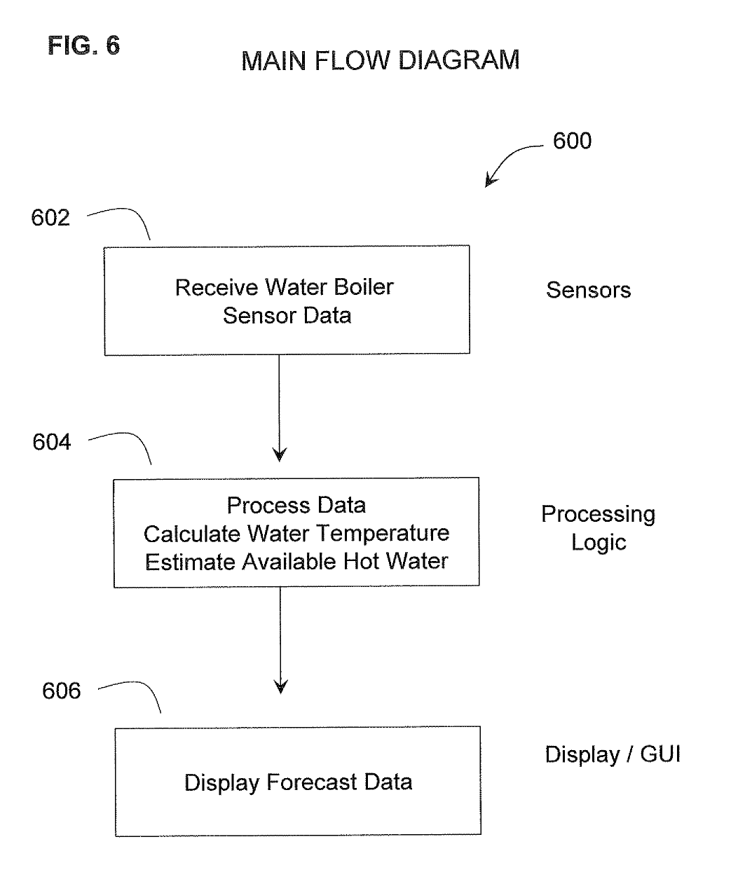

FIG. 6 displays a main flow diagram 600 of the immediate invention. In step 602 of the flow, the forecast system receives sensor data. In step 604 the sensor data is processed to calculate an approximate amount of available hot water. In step 606 the calculated values are displayed in various forms (e.g. as a liquid quantity, as an amount of hot-water activities that can be accomplished, as a function of time, as in how long the hot water will last before it runs out, etc.).

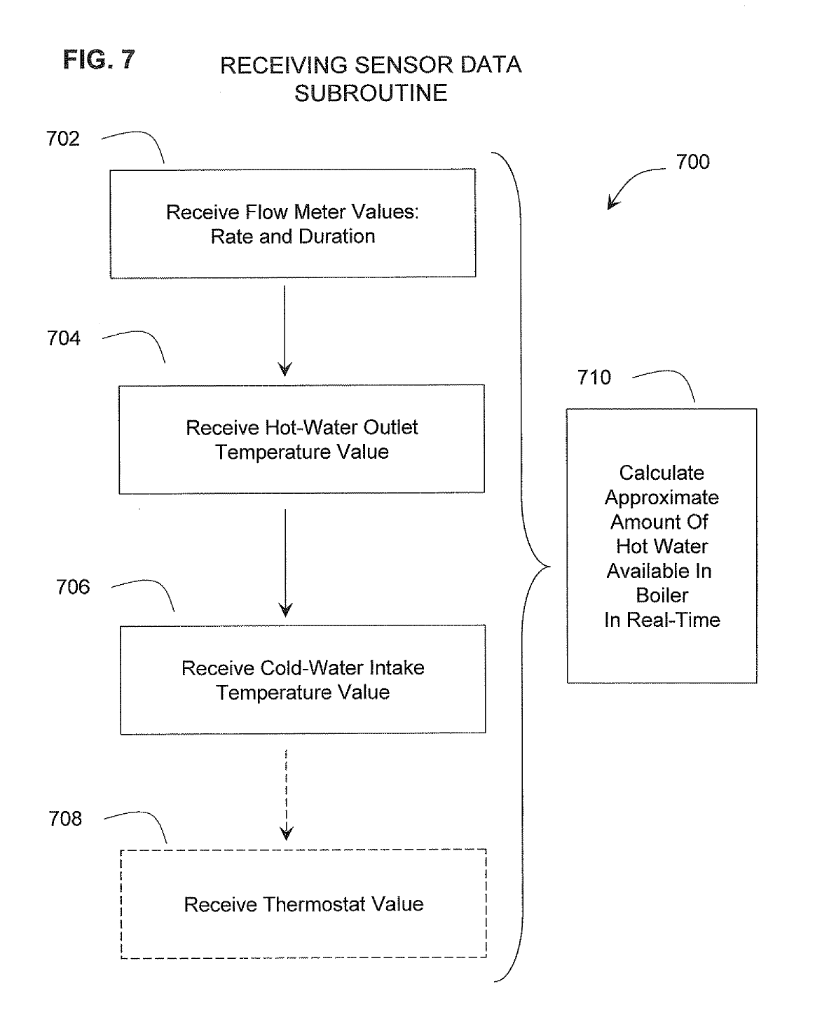

FIG. 7 illustrates a more detailed flow diagram 700 of a subroutine for receiving sensor data. In step 702 a flow meter measurement/value/data is received. In some embodiments, the measurement/data includes a flow rate value and a flow duration value. In step 704, a hot-water outlet temperature measurement of water in a boiler outlet pipe is received. In step 706, a cold-water intake temperature measurement of water in a boiler intake pipe is received. In some embodiments of the system, a thermostat value is received in step 708. In step 710, the sensor data is used to calculate an approximate/estimate the amount of hot-water available in the boiler tank—in real time.

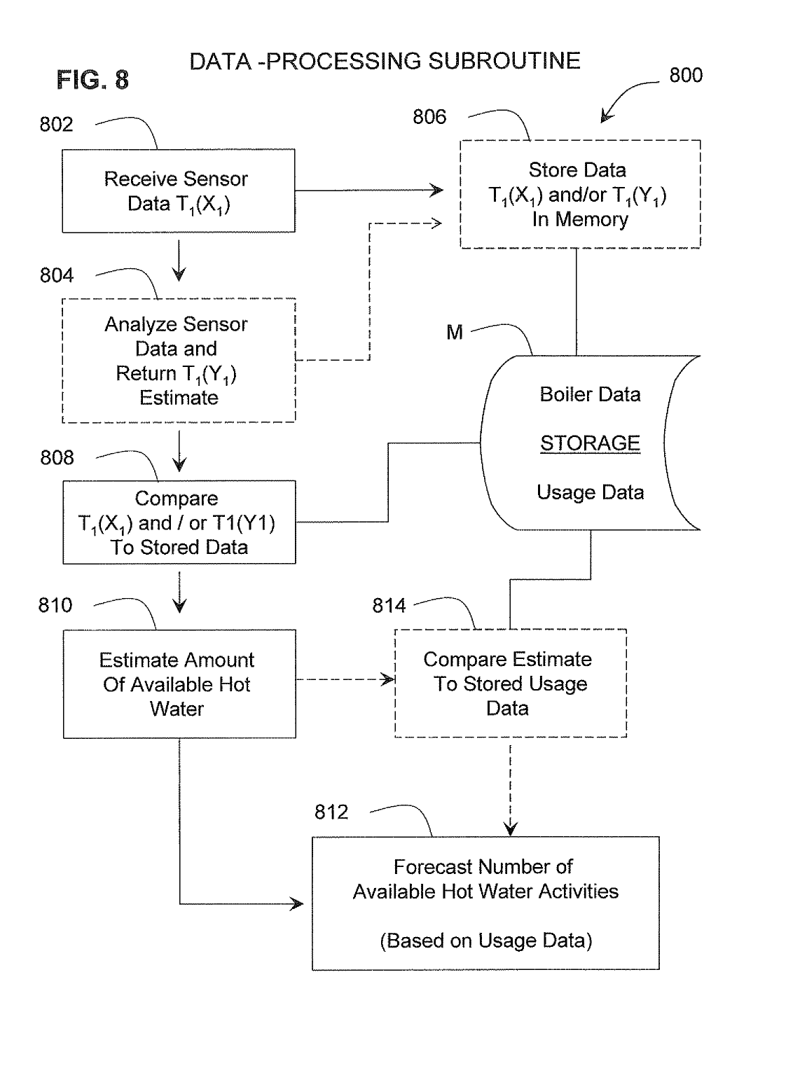

FIG. 8 illustrates a data processing subroutine in a flow chart 800. In step 802, the system receives sensor data (X₁) for a given period of time (T₁). The sensor data is substantially the same as the sensor data described in flow diagram 700 of FIG. 7. In step 804 the sensor data T₁(X₁) is analyzed by the processing unit and an estimated amount of available hot-water T₁(Y₁) is calculated based on the data. In some embodiments step 804 is skipped. In some embodiments, the received sensor data T₁(X₁) is stored in a memory/storage unit M (e.g. a transient or non-transient storage medium or combination thereof) in step 806. In other embodiments, the estimate T₁(Y₁) is stored in memory M in step 806. In still other embodiments both the received data T₁(X₁) and the calculated estimate T₁(Y₁) are stored in memory M.

In all of the aforementioned configurations, the data for the current time period (T₁) is compared to the relevant stored data in step 808. Based on the comparative data and/or other calculations and algorithms applied to the combined data, a more accurate estimate of available hot water is received in step 810. In some embodiments, the amount of estimated available hot-water is then processed into various user-friendly formats in step 812. Some formats include: a number of hot water activities available (e.g. 6 showers, 2 baths, 1 bath & 3 showers, 1 dishwasher load and 1 laundry load, 2 showers and 1 sink of dishes, etc.); an amount of time hot water would be available at a predetermined flow rate; an amount of time before sufficient water is heated to a sufficient temperature for a requested number of hot-water activities and the like. The displayed forecast data, in step 812 can be based on predefined value or amounts for each activity. For example, the national average for hot water usage during a shower is between 6-8 Gallons in the US.

In other embodiments, the estimate received in step 810 is compared to stored usage data, in step 814. Usage data includes various pieces of useful information stored over time. The usage data relates, as the name implies, to the household usage of water, for that particular household. For example, usage data can include family patterns of hot water usage which is learned by an adaptive learning algorithm over time.

One example of possible usage data is the distinction between adult usage and child usage; a child may shower for longer or earlier in the evening, whereas an adult may have a shorter shower and/or later at night. An adult bath may include more water in general and more hot-water in particular, whereas a child bath usually is not as hot or as full.

Usage data can be stored in storage M and patterns relating to usage will emerge over time. The stored data (relating to distinct usage activities, e.g. how much hot water was used for how long at what time of the day, etc.) and/or extrapolated patterns can be accessed, in step 814, and compared to the estimate from step 810. Based on the usage pattern and/or other usage data the system or processing unit can provide a more accurate forecast of available hot water activities in step 812. In these embodiments, the forecast data is displayed in user friendly formats based on stored usage data specific to the particular household.

In some embodiments, the system is electronically coupled to an offsite centralized system. The connection may be via wired or wireless means well known in the art. The system may, based on specific permissions given by the owners, transmit various data to the centralized system for storage and analysis. The centralized/offsite system may analyze the transmitted data and offer to provide remote assistance. For example, the offsite system (whether manned, automated or a combination of both) may recognize a pattern in the transmitted data which indicates a water leak, or a boiler element which is no longer working efficiently etc. The offsite system may provide alerts or offer advice to improve the household hot-water system.

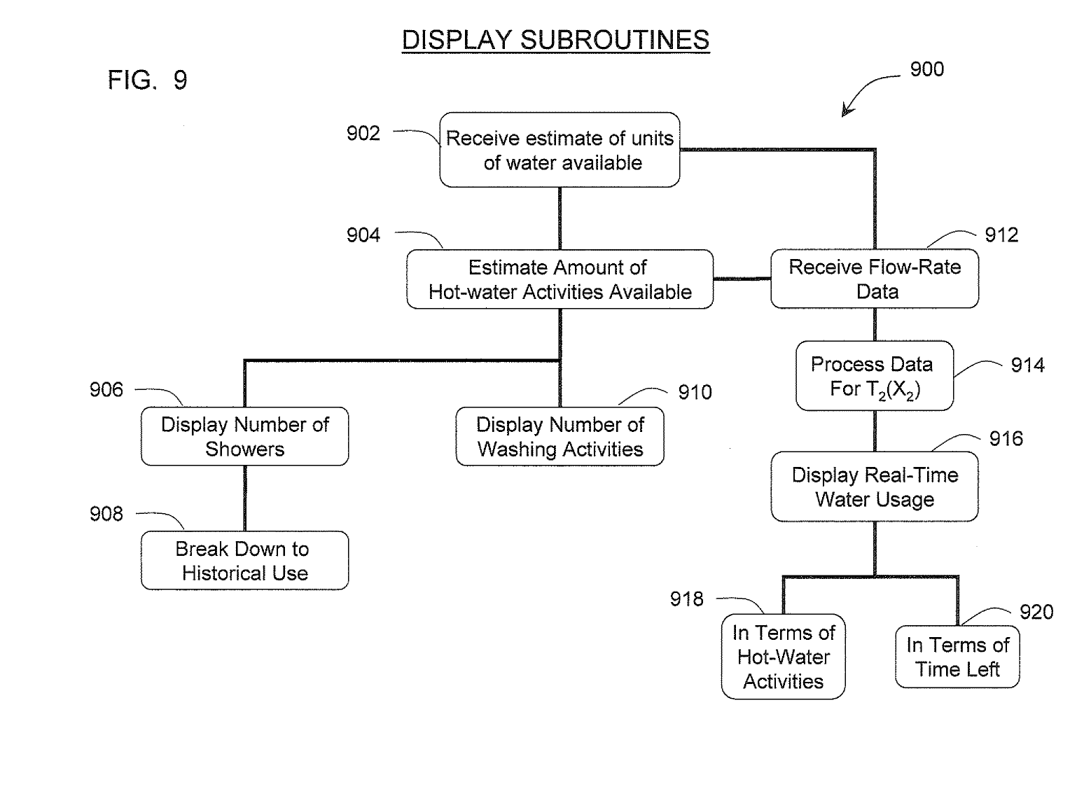

FIG. 9 illustrates a flow diagram 900 relating to a display subroutine. The processing unit is operationally coupled to the display panel. In some embodiments, the processing unit includes a computer program product which is embodied on a non-transitory storage medium and executed via a processor of the processing unit. Preferably the system includes at least one display panel. In some systems, two or more display panels may be included. For example, a main display unit may be located in a central place selected for household use, e.g. outside a main bathroom. The main display/control panel may be used to program the hot-water system or view the amount of hot water or hot-water activities currently available, or the amount of time required before the requisite amount of hot water is available. In preferred embodiments, a display panel is located inside the bathing area. The display panel inside the bathing area is adapted to display real-time values of available hot-water and in particular, how the user's usage of the hot-water affects availability. For example, a user is able to see, during the course of a shower, how much hot-water is being utilized and how much hot water remains in the system at the time.

In preferred embodiments of the system, in step 902, the processing unit receives the value/data of the estimated amount of available hot water, for example, as calculated in step 810 or 814 of flow 800 in FIG. 8. In step 904, the estimated amount or number of hot water activities which are available is displayed on the display panel. In step 906 the number of bathing activities (e.g. showers, bathes) is displayed on the display panel (e.g. the main display panel outside the bathroom). In step 908 a break-down display of the bathing activities available is shown. For example, based on historical use or predefined values, a number of adult and/or child bathing activities is displayed (examples have been mentioned above). In step 910 the number of washing activities is displayed. Washing activities may include dishwasher use, laundry machine use, sink use for washing a load of dished etc. The control/display panel may include functional buttons for changing display modes, for example, between bathing and washing activities. Alternatively and/or additionally, a combination mode may exist and/or a selection function and the like.

In step 912, which may subsequent or simultaneous to step 904, processing unit receives flow rate data from the flow meter. The flow rate data (and possibly other sensor data) is processed in step 914 resulting in a new data (X₂) for a new time period (T₂). In step 916 the real-time display of available water is updated. For example, the display panel in the bathing area will show how much hot water is left throughout the duration of the bating activity, where the display is updated periodically. Alternatively and/or additionally, the main display (or any display for that matter), may show an updated number of bathing or washing (or other hot-water) activities available, based on the new data T₂(X₂) (step 918). Alternatively and/or additionally, the display may show an amount of time remaining before the hot water runs out (step 920). Various additional display options have been discussed elsewhere.

While the invention has been described with respect to a limited number of embodiments, it will be appreciated that many variations, modifications and other applications of the invention may be made. Therefore, the claimed invention as recited in the claims that follow is not limited to the embodiments described herein.

What is claimed is:

1. A retrofit water boiler monitoring and forecast system, for a water boiler system which includes a water boiler, a cold-water intake pipe, a hot-water outlet pipe, the retrofit system comprising:
(a) an intake temperature sensor, configured to measure a water temperature in the cold-water intake pipe;
(b) a flow meter, configured to measure a flow rate of water running through the water boiler system;
(c) an outlet temperature sensor, configured to measure a water temperature in the hot-water outlet pipe;
(d) a processing unit, adapted to receive sensor data from said intake temperature sensor, said flow meter, and said outlet temperature sensor, and configured to calculate an amount of available hot water in the water boiler, based on said sensor data; and
(e) a display panel operationally coupled to said processing unit, said display panel configured to display at least one estimated Real-Time Usage Value (RTUV), calculated by said processing unit based on said amount of available hot water.

2. The retrofit system of claim 1, further comprising:
(f) a control panel operationally coupled to said processing unit, including a user interface adapted to receive instructions for programming and controlling said processing unit.

3. The retrofit system of claim 2, wherein said control panel is operationally coupled to an activation switch of the water boiler.

4. The retrofit system of claim 1, wherein said processing unit includes: a non-transient memory adapted to retrievably store usage data, said usage data including said sensor data recorded over time.

5. The retrofit system of claim 1, wherein said display panel is adapted to be mounted in a bathing area.

6. The retrofit system of claim 1, wherein said at least one estimated RTUV is an estimated amount of time remaining during which said hot water will be available, based on said flow rate.

7. The retrofit system of claim 1, wherein said at least one estimated RTUV includes a number of distinct hot-water activities that can be completed with said amount of available hot water.

8. The retrofit system of claim 7, wherein another estimated RTUV displayed on said display panel includes a measure of time remaining for completing one of said distinct hot water activities, based on said flow rate.

9. The retrofit system of claim 1, wherein said at least one Real-Time Usage Value includes a measure of time remaining before a requisite amount of hot water is available.

10. The retrofit system of claim 4, wherein said at least one Real-Time Usage Value includes an indication of a working condition of a heating element of the water boiler system.

11. The retrofit system of claim 10, wherein said working condition of said heating element is calculated based on said sensor data compared to said usage data.

12. The retrofit system of claim 4, wherein said processing unit includes logic for calculating said amount of available hot water, said logic including an adaptive learning algorithm configured to learn characteristics of the water boiler system based on said usage data stored in said non-transient memory.

13. The retrofit system of claim 12, wherein said amount of available hot water is calculated based on said learned characteristics of the water boiler system.

14. The retrofit system of claim 13, wherein said amount of available hot water is further calculated based on learned usage characteristics of the water boiler.

15. The retrofit system of claim 12, wherein said processor calculates a relative level of efficiency of a heating element of the water boiler system, based on said learned characteristics of the water boiler system.

16. The retrofit system of claim 4, wherein said processing unit includes logic for calculating said amount of available hot water, said logic including an adaptive learning algorithm configured to learn usage characteristics of the water boiler based on said usage data.

17. The retrofit system of claim 16, wherein said amount of available hot water is further calculated based on learned characteristics of the water boiler.

18. The retrofit system of claim 1, wherein said processing unit includes logic configured to detect a leak in the water boiler system, based on said sensor data.

19. The retrofit system of claim 1, wherein said processing unit is configured to distinguish between sources of hot-water usage.

20. The retrofit system of claim 1, further adapted for use with a water boiler system including a solar collector, the retrofit system further comprising at least one of:
(i) a second flow meter adapted to measure water flow through said solar collector operationally coupled to the water boiler;
(ii) a solar collector outlet sensor adapted to measure temperature of water flowing from said solar collector to the water boiler; and
(iii) a solar collector intake sensor adapted to measure temperature of water flowing from the water boiler to said solar collector.

21. The retrofit system of claim 20, further comprising a photo voltaic (PV) cell, said PV cell being adapted to provide solar-related data.

22. The retrofit system of claim 21, wherein said PV cell further produces usable energy.

23. A method for providing a real-time estimate of available hot water in a hot water boiler, the method comprising the steps of:
(a) receiving flow data;
(b) receiving an outlet temperature measurement of water in a boiler outlet pipe; and
(c) receiving an intake temperature measurement of water in a boiler intake pipe;
(d) calculating an estimated amount of hot water in the boiler based on said flow data, outlet temperature measurement and intake temperature measurement.

24. The method of claim 23, further comprising the step of:
(e) receiving a thermostat value, prior to step (d).

25. The method of claim 23, wherein said flow data includes at least one of: a flow rate value and a flow duration value.

26. A method for calculating an estimated amount of hot water in a water boiler, the method comprising the steps of:
(a) receiving sensor data over a predetermined time interval, said sensor data including at least: flow data, an outlet temperature measurement of water in a boiler outlet pipe and an intake temperature measurement of water in a boiler intake pipe;
(b) comparing said received sensor data with stored sensor data; and
(c) calculating, based on said comparison, an approximate amount of available hot water in the water boiler.

27. The method of claim 26, further comprising the step of:
(d) storing said received sensor data on a non-transient storage medium.

28. The method of claim 27, wherein said stored sensor data includes aggregated sensor data.

29. The method of claim 27, further comprising the step of:
(d) analyzing said flow sensor data so as to extrapolate usage data.

30. The method of claim 29, wherein said usage data includes:
(i) distinct usage activities,
(ii) usage patterns for said distinct usage activities.

31. The method of claim 30, further comprising the steps of:
(e) calculating, based on said estimated amount of available hot water and said usage patterns, an amount of said distinct usage activities that can be effected; and
(f) displaying said amount of distinct usage activities that can be effected.

32. The method of claim 30, further comprising the steps of:
(e) forecasting, based on said estimated amount of available hot water and said flow sensor data, an amount of time delta for which hot water will be available from the water boiler; and
(f) displaying said time delta.

33. The method of claim 26, further comprising the step of:
(d) analyzing said sensor data to extrapolate water boiler characteristics.

34. The method of claim 33, wherein said water boiler characteristics include at least one of:
(i) boiler efficiency,
(ii) heating time,
(iii) water leakage, and
(iv) environmental affect on said heating time.

36. A computer program product embodied on a non-transitory storage medium and executed via a processor for effecting the steps of claim 31.

37. The retrofit system of claim 22, wherein said usable energy is adapted to power at least the retrofit system.
